(19) United States
(12) Patent Application Publication
(10) Pub. No.: US 2015/0315435 A1
(43) Pub. Date: Nov. 5, 2015

(54) METHOD FOR PRODUCING ONE-COMPONENT MOISTURE-CURING POLYURETHANE COMPOSITION

(71) Applicant: THE YOKOHAMA RUBBER CO., LTD., Minato-ku, Tokyo (JP)

(72) Inventors: Miyuki MORI, HIRATSUKA-CITY, KANAGAWA (JP); Hiroshi FUKUI, HIRATSUKA CITY, KANAGAWA (JP); Kiminori ARAKI, HIRATSUKA CITY, KANAGAWA (JP); Akio IKEDA, HIRATSUKA CITY, KANAGAWA (JP)

(73) Assignee: The Yokohama Rubber Co., Ltd., Minato-ku, Tokyo (JP)

(21) Appl. No.: 14/653,489

(22) PCT Filed: Dec. 6, 2013
(86) PCT No.: PCT/JP2013/082853

§ 371 Date: Jun. 18, 2015

(30) Foreign Application Priority Data
Dec. 20, 2012 (JP) 2012-277658

(51) Int. Cl. C09J 175/12; C08K 3/26; C08K 5/11; C08K 3/04

(52) U.S. Cl. CPC C09J 175/12; C08K 3/04; C08K 3/26; C08K 5/11; C08K 2003/265

(57) ABSTRACT

A method for producing a one-pack moisture-curing polyurethane composition comprising the steps of: a mixing step of mixing a liquid component (A) containing a polyol compound and a powder component (B) containing a filler, and obtaining a paste-like mixture of the liquid component (A) and the powder component (B); a dehydration step of removing at least part of residual moisture in the paste-like mixture after the mixing step; a prepolymer production step of mixing a polyisocyanate compound (C) and the paste-like mixture after the dehydration step, and obtaining a mixture containing a urethane prepolymer produced by a reaction between the polyisocyanate compound (C) and the polyol compound in the paste-like mixture; and a composition production step of mixing the above mixture with a reaction product (D) of an aliphatic isocyanate compound (d1) and an alkoxysilane (d2), and obtaining a one-pack moisture-curing polyurethane composition.

### TECHNICAL FIELD

The present invention relates to a method for producing a one-pack moisture-curing polyurethane composition.

### BACKGROUND

Conventionally, one-pack moisture-curing polyurethane compositions containing urethane prepolymers have been known, and have been used as adhesives, for example.

An example of a method for producing such a one-pack moisture-curing polyurethane composition is the method described in Patent Document 1. According to that method, it is possible to “obtain a one-pack moisture-curing polyurethane composition that can maintain good viscosity and also has excellent thixotropy and good appearance even when a metal catalyst is used in the production of a urethane prepolymer from the perspective of reducing synthesis time” (paragraph[0011] of Patent Document 1).

### PRIOR ART DOCUMENT

### Patent Document

Patent Document 1: Japanese Unexamined Patent Application Publication No. 2007-224150A

### SUMMARY OF THE INVENTION

### Problem to be Solved by the Invention

Conventionally, vehicle window glass has been mounted on a vehicle body via a rubber gasket, but due to poor glass holding capability at a time of collision, it is now mounted directly on the body using an adhesive. In this case, the surfaces to which the adhesive is applied are a window glass and a painted steel sheet which constitutes the body, but from the perspective of improving adhesiveness, a primer is used on both of those surfaces.

Incidentally, a demand for a reduction in the use of a primer has increased recently from the perspectives of the environment, workability, cost, and the like.

Thus, when the present inventors studied one-pack moisture-curing polyurethane compositions obtained by the method described in Patent Document 1, they found that adhesiveness to the body (painted steel sheet) and glass was insufficient, and it was difficult to reduce the use of a primer.

The present invention was conceived in consideration of the foregoing, and an object of the present invention is to provide a method for producing a one-pack moisture-curing polyurethane composition having excellent adhesiveness to a painted steel sheet and glass.

### Means to Solve the Problem

As a result of a diligent research to achieve the above object, the present inventors discovered that adhesiveness is excellent for a one-pack moisture-curing polyurethane composition obtained by obtaining a urethane prepolymer and then adding and mixing a reaction product of an aliphatic isocyanate compound and an alkoxysilane, and they successfully achieved the present invention.

Specifically, the present invention provides the following (1) to (6).

(1) A method for producing a one-pack moisture-curing polyurethane composition having the steps of: a mixing step of mixing a liquid component (A) containing a polyol compound having not less than two hydroxy groups per molecule and a powder component (B) containing a filler, and obtaining a paste-like mixture of the liquid component (A) and the powder component (B); a dehydration step of removing at least part of residual moisture in the paste-like mixture after the mixing step; a prepolymer production step of mixing a polyisocyanate compound (C) having not less than two isocyanate groups per molecule and the paste-like mixture after the dehydration step, and obtaining a mixture containing a urethane prepolymer produced by a reaction between the polyisocyanate compound (C) and the polyol compound in the paste-like mixture; and a composition production step of mixing the above mixture with a reaction product (D) of an aliphatic isocyanate compound (d1) having not less than two isocyanate groups per molecule and an alkoxysilane (d2), and obtaining a one-pack moisture-curing polyurethane composition.

(2) The method for producing a one-pack moisture-curing polyurethane composition according to (1) above, wherein the dehydration step is a step of dehydrating the paste-like mixture such that a moisture content of the paste-like mixture is not greater than 0.050% by mass.

(3) The method for producing a one-pack moisture-curing polyurethane composition according to (1) or (2) above, wherein, in the composition production step, a curing catalyst for inducing moisture curing of the one-pack moisture-curing polyurethane composition is further added.

(4) The method for producing a one-pack moisture-curing polyurethane composition according to any one of (1) to (3) above, wherein, in the prepolymer production step, the polyisocyanate compound (C) and the paste-like mixture obtained by the mixing step are added in that order and mixed.

(5) The method for producing a one-pack moisture-curing polyurethane composition according to any one of (1) to (4) above, wherein, in the prepolymer production step, the polyisocyanate compound (C) and the paste-like mixture obtained by the mixing step are mixed, and then, a metal catalyst that promotes the production reaction of urethane prepolymer is further added and mixed.

(6) The method for producing a one-pack moisture-curing polyurethane composition according to any one of (1) to (5) above, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

### Effect of the Invention

According to the present invention, a method for producing a one-pack moisture-curing polyurethane composition having excellent adhesiveness to a painted steel sheet and glass can be provided.

### BEST MODE FOR CARRYING OUT THE INVENTION

A method for producing a one-pack moisture-curing polyurethane composition of the present invention (referred to as simply “production method of the present invention” hereinafter) is a method for producing a one-pack moisture-curing polyurethane composition comprising the steps of: a mixing step of mixing a liquid component (A) containing a polyol compound having not less than two hydroxy groups per molecule and a powder component (B) containing a filler, and obtaining a paste-like mixture of the liquid component (A) and the powder component (B); a dehydration step of removing at least part of residual moisture in the paste-like mixture after the mixing step; a prepolymer production step of mixing a polyisocyanate compound (C) having not less than two isocyanate groups per molecule and the paste-like mixture after the dehydration step, and obtaining a mixture containing a urethane prepolymer produced by a reaction between the polyisocyanate compound (C) and the polyol compound in the paste-like mixture; and a composition production step of mixing the above mixture with a reaction product (D) of an aliphatic isocyanate compound (d1) having not less than two isocyanate groups per molecule and an alkoxysilane (d2), and obtaining a one-pack moisture-curing polyurethane composition.

According to the production method of the present invention, a one-pack moisture-curing polyurethane composition in which the above urethane prepolymer and the above reaction product (D) are copresent is obtained by separately providing the above prepolymer production step and the above composition production step, and, after producing the above urethane prepolymer, later adding the above reaction product (D).

The one-pack moisture-curing polyurethane composition obtained in this manner has excellent adhesiveness to a painted steel sheet which constitutes a vehicle body and to glass. It is thought that adhesiveness are good due to the fact that an isocyanate (the above reaction product (D)), which contributes to adhesion, is present separately from the isocyanate required in the skeleton of the above urethane prepolymer (the above polyisocyanate compound (C)).

Furthermore, at this time, the aliphatic isocyanate compound (d1) side and the alkoxysilane (d2) side which constitute the reaction product (D) contribute to adhesiveness to a painted steel sheet, and adhesiveness to glass respectively.

Such an effect is also supported by the fact that adhesiveness obtained by adding the reaction product (D) together with the polyisocyanate compound (C) in the prepolymer production step is insufficient in the Working Examples below (see Comparative Examples 2 to 4). In this case, it is thought that the reaction product (D) becomes integrated with a urethane prepolymer and is not in a copresent state.

Each of the components and each of the steps of the production method of the present invention will be described in detail below.

### <Liquid Component (A)>

The above liquid component (A) is not particularly limited provided that it contains a polyol compound having not less than two hydroxy groups per molecule. It may contain only the polyol compound, or may contain, for example, a plasticizer in addition to the polyol compound.

Here, from the perspective of resulting in a liquid at room temperature when mixed in the mixing step to be described later, and from the perspective of viscosity when the urethane prepolymer is produced, the melting point of the polyol compound in the liquid component (A) is preferably not greater than 80° C., and more preferably not greater than 60° C.

The above polyol compound is not particularly limited with respect to molecular weight, skeleton, and the like, provided that it is a compound having not less than two hydroxy groups (OH groups). Specific examples thereof include low-molecular-weight polyhydric alcohol, polyether polyol, polyester polyol, other types of polyol, a polyol mixture thereof, and the like.

Specific examples of the low-molecular-weight polyhydric alcohol include low-molecular-weight polyols such as ethylene glycol (EG), diethylene glycol, propylene glycol (PG), dipropylene glycol, 1,3-butanediol, 1,4-butanediol, pentanediol, neopentyl glycol, hexanediol, cyclohexanedimethanol, glycerin 1,1,1-trimethylolpropane (TMP), 1,2,5-hexanetriol, pentaerythritol, and the like; and sugars such as sorbitol.

Next, the polyether polyol and polyester polyol may generally be compounds derived from the above low-molecular-weight polyhydric alcohol, but in the present invention, compounds derived from the aromatic diol, amine, and alkanolamine shown below may also be favorably used.

Here, specific examples of the aromatic diol include resorcin (m-dihydroxybenzene), xylylene glycol, 1,4-benzene dimethanol, styrene glycol, 4,4′-dihydroxyethyl phenol; and compounds having a bisphenol skeleton of a bisphenol A structure (4,4′-dihydroxyphenylpropane), a bisphenol F structure (4,4′-dihydroxyphenylmethane), a brominated bisphenol A structure, a hydrogenated bisphenol A structure, a bisphenol S structure, and a bisphenol AF structure shown below, and the like.

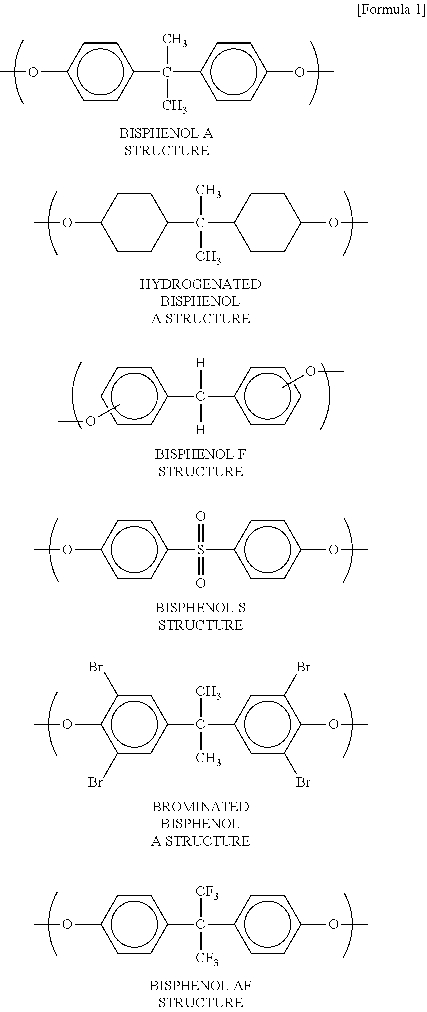

Additionally, specific examples of the amines include ethylenediamine, hexamethylenediamine, and the like. Specific examples of the alkanolamine include ethanolamine, propanolamine, and the like.

Examples of the polyether polyol include polyol obtained by adding at least one oxide selected from the group consisting of styrene oxide and alkylene oxide such as ethylene oxide, propylene oxide, butylene oxide (tetramethylene oxide), tetrahydrofuran, and the like, to at least one compound selected from the group consisting of the low-molecular-weight polyhydric alcohol, the aromatic diol, the amine, the alkanolamine, and the like.

Specific examples of the polyether polyol include polyethylene glycol, polypropylene glycol (PPG), polypropylene triol, ethylene oxide/propylene oxide copolymers, polytetramethylene ether glycol (PTMEG), polytetraethylene glycol, sorbitol polyol, and the like.

Likewise, examples of the polyester polyol include the condensation product (condensed polyester polyols) of any of the low-molecular-weight polyhydric alcohol, the aromatic diol, the amine, or the alkanolamine with a polybasic carboxylic acid; lactone polyol; polycarbonate polyol; and the like.

Specific examples of the polybasic carboxylic acid which may be used here to form the condensed polyester polyol include glutaric acid, adipic acid, azelaic acid, fumaric acid, maleic acid, pimelic acid, suberic acid, sebacic acid, phthalic acid, terephthalic acid, isophthalic acid, dimer acid, pyromellitic acid, other low-molecular-weight carboxylic acid, oligomeric acid, castor oil, hydroxycarboxylic acid such as a reaction product of castor oil and ethylene glycol (or propylene glycol), and the like.

Additionally, specific examples of the lactone polyol include compounds having hydroxy groups at both ends, obtained by ring-opening polymerization of lactone such as ε-caprolactone, α-methyl-ε-caprolactone, ε-methyl-ε-caprolactone, or the like with a suitable polymerization initiator.

Examples of other polyol include polymeric polyol having carbon-carbon bonds on a backbone skeleton, such as acrylic polyol, polybutadiene polyol, hydrogenated polybutadiene polyol, and the like.

In the present invention, the various polyol compounds exemplified above may be used alone or may be used in any combination of two or more types.

Among these, polypropylene glycol is preferred due to an excellent balance between the hardness and elongation at fracture and the balance with cost of a one-pack moisture-curing polyurethane composition containing a liquid component (A).

Furthermore, a polyol having weight-average molecular weight from about 100 to 10,000 is preferred, and 1000 to 5000 is more preferred. If the weight-average molecular weight is in this range, the physical properties (for example, hardness, fracture strength, elongation at fracture) and viscosity of the urethane prepolymer produced by the reaction with the polyisocyanate compound (C) to be described later are good.

Specific examples of the plasticizer include diisononyl adipate (DINA); diisononyl phthalate (DINP); dioctyl adipate, isodecyl succinate; diethylene glycol dibenzoate, pentaerythritol ester; butyl oleate, methyl acetyl ricinoleate; tricresyl phosphate, trioctyl phosphate; propylene glycol adipate polyester, butylene glycol adipate polyester, and the like. These may be used alone or may be used in any combination of two or more types.

Among these, diisononyl adipate (DINA) or diisononyl phthalate (DINP) is preferred due to excellent cost and compatibility.

Furthermore, when the liquid component (A) contains the above plasticizers, the content thereof is not particularly limited, but is preferably from 20 to 80 parts by mass, and more preferably from 30 to 70 parts by mass, per 100 parts by mass of the total of the polyol compound and the polyisocyanate compound (C).

### <Powder Component (B)>

The powder component (B) is not particularly limited provided that it contains a filler, and it may contain only the filler, or, in addition to the filler, it may contain various additives such as, for example, antiaging agents, antioxidants, pigments (dyes), thixotropic agents, UV absorbents, flame retardants, surfactants (including leveling agents), dispersion agents, dehydrating agents, adhesion promoters, antistatic agents, and the like.

The filler can be an organic or inorganic filler of any form. Specific examples include fumed silica, calcined silica, precipitated silica, pulverized silica, molten silica; diatomaceous earth; iron oxide, zinc oxide, titanium oxide, barium oxide, magnesium oxide; calcium carbonate, heavy calcium carbonate, sedimentary calcium carbonate (light calcium carbonate), colloidal calcium carbonate, magnesium carbonate, zinc carbonate; pyrophyllite clay, kaolin clay, calcined clay; carbon black; fatty acid treated products, resin acid treated products, urethane compound treated products, and fatty acid ester treated products thereof; and the like. These may be used alone or may be used in any combination of two or more types.

Among these, carbon black and heavy calcium carbonate are preferred because the viscosity and thixotropy of the one-pack moisture-curing polyurethane composition are easy to adjust. Specifically, when carbon black is used, physical properties (for example, hardness, elongation, and the like) are excellent, and when heavy calcium carbonate is used, deep curing characteristics are excellent.

Furthermore, carbon black pellets are preferred not only because workability is good, but also because, as will be described later, dehydration not only of carbon black but of the liquid component (A) is further promoted in the mixing step with the liquid component (A).

Specific examples of the antiaging agents include compounds such as a hindered phenol compound and the like.

Specific examples of the antioxidants include butylhydroxytoluene (BHT), butylhydroxyanisole (BHA), and the like.

Specific examples of the pigment include inorganic pigments such as titanium oxide, zinc oxide, ultramarine, iron red, lithopone, lead, cadmium, iron, cobalt, aluminum, hydrochlorides, sulfates, and the like; organic pigments such as azo pigments, phthalocyanine pigments, quinacridone pigments, quinacridonequinone pigments, dioxazine pigments, anthrapyrimidine pigments, anthanthrone pigments, indanthrone pigments, flavanthrone pigments, perylene pigments, perinone pigments, diketopyrrolopyrrole pigments, quinonaphthalone pigments, anthraquinone pigments, thioindigo pigments, benzimidazolone pigments, isoindoline pigment, carbon black, and the like; and the like.

Specific examples of the thixotropic agent include Aerosil (manufactured by Nippon Aerosil), Disparlon (manufactured by Kusumoto Chemicals, Ltd.), and the like.

Specific examples of the tackifier include terpene resins, phenol resins, terpene-phenol resins, rosin resins, xylene resins, and the like.

Specific examples of the flame retardant include chloroalkyl phosphates, dimethyl-methyl phosphates, bromine-phosphorus compounds, ammonium polyphosphates, neopentyl bromide polyethers, brominated polyethers, and the like.

Specific examples of the antistatic agent include quaternary ammonium salts; hydrophilic compounds such as polyglycols, ethylene oxide derivatives; and the like.

Furthermore, the compounding ratio of the powder component (B) is not particularly limited, but is preferably from 50 to 150 parts by mass, and more preferably from 70 to 130 parts by mass, per 100 parts by mass of the total of the polyol compound and the polyisocyanate compound (C).

### <Polyisocyanate Compound (C)>

The polyisocyanate compound (C) is not particularly limited provided that it is a polyisocyanate compound having not less than two isocyanate groups per molecule. Specific examples include aromatic polyisocyanates such as tolylene diisocyanate (TDI), diphenylmethane diisocyanate (MDI), 1,4-phenylene diisocyanate, polymethylene polyphenylene polyisocyanate, xylylene diisocyanate (XDI), tetramethylxylylene diisocyanate (TMXDI), tolidine diisocyanate (TODI), 1,5-naphthalene diisocyanate (NDI), triphenylmethane triisocyanate, and the like; aliphatic polyisocyanates such as hexamethylene diisocyanate (HDI), trimethylhexamethylene diisocyanate (TMHDI), lysine diisocyanate, norbornane diisocyanate methyl (NBDI), and the like; alicyclic polyisocyanates such as transcyclohexane-1,4-diisocyanate, isophorone diisocyanate (IPDI), bis(isocyanate methyl)cyclohexane (H₆XDI), dicyclohexylmethane diisocyanate (H₁₂MDI), and the like; carbodiimide-modified polyisocyanates and isocyanurate-modified polyisocyanates of these polyisocyanate compounds; and the like. These may be used alone or may be used in any combination of two or more types.

Among these, aromatic polyisocyanates are preferred, and tolylene diisocyanate (TDI) and diphenylmethane diisocyanate (MDI) are more preferred as the polyisocyanate compound (C) because adhesiveness is better due to the fact that the produced urethane prepolymer is difficult to mix with and is more readily copresent with the reaction product (D) to be described later.

Furthermore, the compounding ratio of the polyisocyanate compound (C) is not particularly limited, but it is preferably a ratio such that the equivalence ratio of the isocyanate groups (NCO) of the polyisocyanate compound (C) to the hydroxy groups (OH) of the polyol compound is, for example, from 1.1 to 2.5.

### <Reaction Product (D)>

The reaction product (D) is a reaction product produced by a reaction of an aliphatic isocyanate compound (d1) having not less than two isocyanate groups per molecule and an alkoxysilane (d2).

(Aliphatic Isocyanate Compound (d1))

The aliphatic isocyanate compound (d1) is not particularly limited provided that it is an aliphatic isocyanate compound having not less than two isocyanate groups per molecule. Examples include the aliphatic polyisocyanates given as examples of the above polyisocyanate compound (C).

Specific examples of the aliphatic isocyanate compound (d1) include aliphatic polyisocyanates such as hexamethylene diisocyanate (HDI), trimethylhexamethylene diisocyanate (TMHDI), lysine diisocyanate, norbornane diisocyanate methyl (NBDI), and the like. These may be used alone or may be used in any combination of two or more types.

Furthermore, in addition to the above aliphatic polyisocyanates, the aliphatic isocyanate compound (d1) may be, for example, a reaction product of the above aliphatic polyisocyanates and a triol; a modified body such as a biuret or an isocyanurate of the above aliphatic polyisocyanates; or the like. These may be used alone or may be used in any combination of two or more types.

Here, the triol is not particularly limited provided that it has three hydroxy groups per molecule, but examples include 1,2,5-hexanetriol, 1,2,6-hexanetriol, 1,2,3-propanetriol, 1,2,3-benzenetriol, 1,2,4-benzenetriol, trimethylolethane, trimethylolpropane, and the like.

Because the effect of adhesiveness is better, the aliphatic isocyanate compound (d1) is preferably at least one type selected from the group consisting of a reaction product of HDI and trimethylolpropane, HDI biuret, and HDI isocyanurate.

(Alkoxysilane (d2))

The alkoxysilane (d2) is not particularly limited provided that it reacts with the above aliphatic isocyanate compound (d1) to give the above reaction product (D), but, for example, an imino group-containing alkoxysilane is preferably used. The imino group-containing alkoxysilane has an imino group (NH), which reacts with the isocyanate group (NCO) of the aliphatic isocyanate compound (d1) to give a urea group.

The imino group-containing alkoxysilane is not particularly limited provided that it is a compound having an imino group and an alkoxysilyl group, but examples include (N-cyclohexylaminomethyl) methyldiethoxysilane, (N-cyclohexylaminomethyl)triethoxysilane, (N-phenylaminomethyl) methyldimethoxysilane, (N-phenylaminomethyl) trimethyloxysilane, N-phenyl-3-aminopropyltrimethoxysilane, and the like. These may be used alone or may be used in any combination of two or more types.

Among these, N-phenyl-3-aminopropyltrimethoxysilane is preferred from the perspective of ease of procurement.

The mixing ratio when the aliphatic isocyanate compound (d1) and the alkoxysilane (d2), which is an imino group-containing alkoxysilane, are reacted is preferably a ratio such that the molar ratio (NCO/NH) of the isocyanate groups (NCO) of the aliphatic isocyanate compound (d1) to the imino groups (NH) of the imino group-containing alkoxysilane is from 2/1 to 3/1, and more preferably 3/1.

Because the effect of adhesiveness is better, the above reaction product (D) is preferably a reaction product of the above aliphatic isocyanate compound (d1), which is at least one type selected from the group consisting of a reaction product of hexamethylene diisocyanate and trimethylolpropane, a biuret of hexamethylene diisocyanate, and a isocyanurate of hexamethylene diisocyanate; and the above alkoxysilane (d2), which is the above imino group-containing alkoxysilane.

Furthermore, the compounding ratio of the reaction product (D) is not particularly limited, but because the effect of adhesiveness is better, it is preferably from 0.5 to 15 parts by mass, and more preferably from 2 to 10 parts by mass, per 100 parts by mass of the total of the polyol compound and the polyisocyanate compound (C).

### [Mixing Step]

The mixing step in the production method of the present invention is a step of mixing the above liquid component (A) and the above powder component (B), and obtaining a paste-like mixture of the liquid component (A) and the powder component (B).

Here, the method of mixing the liquid component (A) and the powder component (B) is not particularly limited provided that it is a conventionally known mixing method, but favorable specific examples include mixing methods using rollers, kneaders, pressure kneaders, Banbury mixers, horizontal mixers (for example, a Loedige mixer or the like), vertical mixers (for example, a planetary mixer or the like), and universal mixers.

The mixing temperature and time are not particularly limited because they differ depending on the types of the liquid component (A) and the powder component (B), but a temperature from about 20 to 110° C. and a time from 30 min to 2 h are preferred. Furthermore, because the liquid component (A) needs to be a liquid at the temperature of mixing in the mixing step, if, for example, the mixing temperature is 100° C., a liquid component (A) containing a polyol compound having a melting point lower than that temperature needs to be used.

In the present invention, some of the moisture in the liquid component (A) and the powder component (B) can be removed by having such a mixing step.

This is thought to be because when the liquid component (A) and the powder component (B) are mixed, the powder component (B) is readily broken down due to the absence of a solvent such as toluene or the like, and moisture may be removed by pressure or heat generation that occurs at that time.

Furthermore, in the present invention, if carbon black pellets are used as the powder component (B), in the mixing step, the liquid component (A) and carbon black pellets are preferably mixed while the carbon black pellets are being crushed.

This is because the pressure and heat generation mentioned above increase due to crushing of the carbon black pellets, which further promotes dehydration of the liquid component (A) and the carbon black pellets.

Here, among the mixing methods exemplified above, the method of mixing while crushing is preferably a method wherein mixing is performed using a horizontal mixer (for example, a Loedige mixer or the like), which can mix in a state where pressure is applied to the carbon black pellets when mixing.

### [Dehydration Step]

The dehydration step in the production method of the present invention is a step of removing at least part of residual moisture in the paste-like mixture.

Here, a specific example of a method for removing residual moisture is drying under vacuum (not greater than 1.2 kPa, and preferably from 0.6 to 1.2 kPa) at a temperature from 30 to 60° C. for not less than 30 min.

The reasons that residual moisture may be removed by this simple method are because the mixture is paste-like, and, as described above, because of the unexpected removal of some of the moisture by pressure or heat generation produced when the powder component is broken down in the mixing step.

The present inventors further discovered that when dehydration (drying) in the paste-like mixture was insufficient, it might affect the presence of the reaction product (D) added in the composition production step to be described later, and the adhesiveness of the obtained composition might decrease.

For this reason, from the perspective of obtaining better adhesiveness by sufficient dehydration in the paste-like mixture, when drying is performed at a temperature from 30 to 60° C. at pressure not greater than 1.2 kPa, the drying time is preferably from 30 to 180 min, and more preferably from 60 to 150 min.

Furthermore, from the same perspective, the moisture content of the paste-like mixture is preferably not greater than 0.050% by mass, more preferably not greater than 0.025% by mass, and even more preferably not greater than 0.015% by mass by the above method in the dehydration step.

Note that the moisture content of the paste-like mixture is measured by the Karl Fischer method. Specifically, the moisture content can be measured according to the coulometric titration method, using a water content measurement instrument (manufactured by Mitsubishi Chemical Corporation) and using an electrolytic solution having iodide ions, sulfur dioxide, and alcohol as the primary components (brand name Aquamicron CXU, manufactured by API Corporation) as a Karl Fischer reagent.

### [Prepolymer Production Step]

The prepolymer production step in the production method of the present invention is a method of mixing the polyisocyanate compound (C) and the paste-like mixture after the dehydration step, and obtaining a mixture containing a urethane prepolymer produced by a reaction between the polyisocyanate compound (C) and the polyol compound in the paste-like mixture.

The above mixture contains, in addition to the above urethane prepolymer, at least the above powder (B) derived from the above paste-like mixture.

Here, the method for mixing the polyisocyanate compound (C) and the paste-like mixture is favorably the same methods exemplified in the above mixing step.

Furthermore, the mixing temperature and atmosphere are not particularly limited because they differ depending on the type of polyol compound in the paste-like mixture and the type of polyisocyanate compound (C), but from the perspective of producing a urethane prepolymer, mixing at a temperature not lower than the melting point of the polyisocyanate compound (C) is preferred, and mixing under an inert gas atmosphere such as nitrogen, argon or the like or under reduced pressure is preferred.

In the present invention, due to having this prepolymer production step, the powder component (B) in the paste-like mixture is broken down due to an increase in viscosity that accompanies prepolymerization of a urethane prepolymer, resulting in good dispersibility and good thixotropy of the one-pack moisture-curing polyurethane composition.

Furthermore, in the prepolymer production step in the present invention, adding the polyisocyanate compound (C) and the paste-like mixture in that order and mixing them is preferred for the following reason.

Specifically, by adding them in that order, stabilized reaction of a urethane prepolymer occurs because the polyol compound is added into the polyisocyanate compound (C), resulting in a urethane prepolymer with uniform molecular weight being produced.

On the other hand, in the prepolymer production step in the present invention, adding the paste-like mixture and the polyisocyanate compound (C) in that order and mixing them is preferred for the following reason.

Specifically, by adding them in that order, workability is better because, for example, in the horizontal mixer used in the mixing step to obtain the paste-like mixture, the prepolymer production step can be carried out by adding the polyisocyanate compound (C) as-is.

In the present invention, in the prepolymer production step, the polyisocyanate compound (C) and the paste-like mixture are mixed, and then, a metal catalyst that promotes the production reaction of urethane prepolymer is preferably further added and mixed.

As a result, good viscosity of the produced urethane prepolymer can be maintained. This is thought to be because, due to the metal catalyst being added in the presence of the powder component (B), a rapid reaction of producing the urethane prepolymer does not occur, and therefore good viscosity can be maintained.

Examples of this metal catalyst include organometallic catalysts, specific examples thereof include dibutyltin dilaurate, dioctyltin laurate (DOTL), dioctyltin dilaurate, and bismuth catalysts (for example, inorganic bismuth (Neostann U-600, U-660) manufactured by Nitto Kasei Co., Ltd., and the like).

When the above metal catalyst is used, the compounding ratio thereof is preferably from 0.001 to 0.02 parts by mass, and more preferably from 0.002 to 0.01 parts by mass, per 100 parts by mass of the total of the polyol compound and the polyisocyanate compound (C).

Furthermore, in the prepolymer production step, the production rate of the urethane prepolymer is preferably high, and preferably at least 80%, because the reaction product (D) mixes less readily with the urethane prepolymer and adhesiveness are better.

At this time, the production rate of the urethane prepolymer can be determined from the NCO % in the mixture, as measured by hydrochloric acid reverse titration.

### [Composition Production Step]

The composition production step in the production method of the present invention is a step of mixing the above mixture and the reaction product (D), and obtaining a one-pack moisture-curing polyurethane composition.

The obtained one-pack moisture-curing polyurethane composition contains, at least, the powder (B), the urethane prepolymer, and the reaction product (D).

Here, the method for mixing the mixture and the reaction product (D) is favorably the same methods exemplified in the above mixing step.

Furthermore, the mixing temperature and atmosphere are not particularly limited, but mixing at a temperature not lower than the melting point of the reaction product (D) is preferred, and mixing under an inert gas atmosphere such as nitrogen, argon or the like or under reduced pressure is preferred.

In the present invention, after the urethane prepolymer is produced in the prepolymer production step, the reaction product (D) is added in the composition production step, thereby a one-pack moisture-curing polyurethane composition in which the urethane prepolymer and the reaction product (D) are copresent can be obtained, and this composition has excellent adhesiveness to a painted steel sheet and glass.

Furthermore, in the composition production step, a curing catalyst for inducing moisture curing of the obtained one-pack moisture-curing polyurethane composition is preferably further added. By so doing, the effect of adhesiveness becomes better.

The curing catalyst is not particularly limited provided that it induces moisture curing, but conventionally known curing catalysts may be used. Specific examples thereof include the organometallic catalysts listed as examples of the metal catalyst used in the prepolymer production step.

When the above curing catalyst is used, the compounding ratio thereof is preferably from 0.001 to 0.05 parts by mass, and more preferably from 0.002 to 0.03 parts by mass, per 100 parts by mass of the total of the polyol compound, the polyisocyanate compound (C), and the reaction product.

As described above, the one-pack moisture-curing polyurethane composition obtained by the production method of the present invention is favorable for adhesive applications such as, for example, for vehicles and construction due to its excellent adhesiveness.

Above all, because this composition has good adhesiveness to a painted steel sheet and glass, it is possible to avoid the use of primers conventionally used at the interface between the painted steel sheet and the adhesive and the interface between the glass and the adhesive when mounting vehicle window glass on the body (painted steel sheet).

### EXAMPLES

The present invention will be described in detail below with reference to working examples. However, the present invention is not limited to these examples.

### Working Examples 1 to 7

### Mixing Step

First, in a Loedige mixer (manufactured by Matsubo Corporation), polyol compounds 1 and 2 and a plasticizer were added as a liquid component (A), and then carbon black and calcium carbonate were added as a powder component (B). The components were agitated at 110° C. for 2 hours to prepare a paste-like mixture. Note that the added amounts (compounding ratio) are as shown in Table 1 below (similarly hereinafter).

### (Dehydration Step)

Next, the interior of the Loedige mixer containing the paste-like mixture was set from 30 to 60° C. and to not greater than 1.2 kPa, and the mixture was dried for the time (units: min) shown in Table 1 below. The moisture content (units: % by mass) of the paste-like mixture after drying was measured. The results are shown in Table 1 below.

### (Prepolymer Production Step)

Then, in a planetary mixer, MDI was added as polyisocyanate compound (C), and the above paste-like mixture after drying was further added, after which a metal catalyst was added. This mixture was agitated for 1 hour at 60° C. to react the MDI and the polyol compounds 1 and 2 in the paste-like mixture, thereby producing a urethane prepolymer.

### (Composition Production Step)

Next, in the planetary mixer in which the urethane prepolymer was produced, the reaction product (D) shown in Table 1 below was added, and a curing catalyst was further added. This mixture was agitated for 10 min at 60° C., to prepare a one-pack moisture-curing polyurethane composition (also simply called “composition” hereinafter).

### Comparative Example 1

A one-pack moisture-curing polyurethane composition was prepared in the same manner as Working Examples 1 to 7, except that in the composition production step, the reaction product of an aromatic isocyanate compound and an alkoxysilane (d2) was added instead of the reaction product (D), which is the reaction product of an aliphatic isocyanate compound (d1).

Note that although the reaction product used is not the reaction product (D), for convenience, it is listed under “(D) addition step” in Table 1 below.

### Comparative Examples 2 to 4

In the prepolymer production step, the reaction product (D) was added and mixed together with the addition of polyisocyanate compound (C), thereby producing a urethane prepolymer. In the composition production step, only a curing catalyst was added. Other than that, a one-pack moisture-curing polyurethane composition was prepared in the same manner as Working Examples 1 to 7.

### Comparative Example 5

In the composition production step, only a curing catalyst was added without the reaction product (D) being added. Other than that, a one-pack moisture-curing polyurethane composition was prepared in the same manner as Working Examples 1 to 7.

Note that in Comparative Example 5, because the reaction product (D) was not added, “-” is denoted under “(D) addition step” in Table 1 below.

### <Adhesiveness>

### (Adhesiveness to Painted Steel Sheet)

A painted steel sheet coated with a coating material was coated with the compositions of Working Examples 1 to 7 and Comparative Examples 1 to 5, and after leaving the sheet to stand for 24 hours under an atmosphere at 20° C., 60% RH (±5%), test pieces were obtained. A hand peel test by knife cutting was carried out using the obtained test pieces.

In the hand peel test results, test pieces in which cohesive failure occurred for the entire composition but adhesive failure did not occur were assessed as having excellent adhesiveness, denoted as ⊚; those in which adhesive failure occurs in less than 20% of the coating area but cohesive failure occurred in the remainder were assessed as having somewhat good adhesiveness, denoted as ∘; those in which adhesive failure occurred in not less than 20% and less than 50% of the coating area were assessed as having somewhat poor adhesiveness, denoted as Δ; and those in which adhesive failure occurred in not less than 50% of the coating area were denoted as x. The results are shown in Table 1 below.

### (Adhesiveness to Glass)

The same test as above was carried out except that an adherend was changed to ceramic printed glass used in windshields of vehicles and the like. The results are shown in Table 1 below.

TABLE 1

| | | Working Example | | | | | | | Comparative Example | | | | |
|---|---|---|---|---|---|---|---|---|---|---|---|---|---|
| | | 1 | 2 | 3 | 4 | 5 | 6 | 7 | 1 | 2 | 3 | 4 | 5 |
| (A) | Polyol compound 1 | 25 | 25 | 25 | 25 | 25 | 25 | 25 | 25 | 25 | 25 | 25 | 25 |
| | Polyol compound 2 | 50 | 50 | 50 | 50 | 50 | 50 | 50 | 50 | 50 | 50 | 50 | 50 |
| | Plasticizer | 50 | 50 | 50 | 50 | 50 | 50 | 50 | 50 | 50 | 50 | 50 | 50 |
| (B) | Carbon black | 50 | 50 | 50 | 50 | 50 | 50 | 50 | 50 | 50 | 50 | 50 | 50 |
| | Calcium carbonate | 50 | 50 | 50 | 50 | 50 | 50 | 50 | 50 | 50 | 50 | 50 | 50 |
| (C) | MDI | 10 | 10 | 10 | 10 | 10 | 10 | 10 | 10 | 10 | 10 | 10 | 10 |
| Metal catalyst | | 0.003 | 0.003 | 0.003 | 0.003 | 0.003 | 0.003 | 0.003 | 0.003 | 0.003 | 0.003 | 0.003 | 0.003 |
| (D) | HDI biuret- | 2 | 0 | 0 | 4 | 6 | 0 | 2 | 0 | 2 | 0 | 0 | 0 |
| | aminosilane | | | | | | | | | | | | |
| | HDI TMP adduct- | 0 | 2 | 0 | 0 | 0 | 0 | 0 | 0 | 0 | 2 | 0 | 0 |
| | aminosilane | | | | | | | | | | | | |
| | HDI isocyanurate- | 0 | 0 | 2 | 0 | 0 | 0 | 0 | 0 | 0 | 0 | 2 | 0 |
| | aminosilane | | | | | | | | | | | | |
| | HDI-aminosilane | 0 | 0 | 0 | 0 | 0 | 2 | 0 | 0 | 0 | 0 | 0 | 0 |
| Aromatic isocyanate | | 0 | 0 | 0 | 0 | 0 | 0 | 0 | 2 | 0 | 0 | 0 | 0 |
| compound-aminosilane | | | | | | | | | | | | | |
| Curing catalyst | | 0.01 | 0.01 | 0.01 | 0.01 | 0.01 | 0.01 | 0.01 | 0.01 | 0.01 | 0.01 | 0.01 | 0.01 |
| Drying time/min | | 60 | 60 | 60 | 60 | 60 | 60 | 30 | 60 | 60 | 60 | 60 | 60 |
| Moisture/% by mass | | 0.01 | 0.01 | 0.01 | 0.01 | 0.01 | 0.01 | 0.03 | 0.01 | 0.01 | 0.01 | 0.01 | 0.01 |
| (D) Addition step | | Composition production step | | | | | | | | Prepolymer | | | — |
| | | | | | | | | | | production step | | | |
| Adhesive- | Painted steel sheet | ⊚ | ⊚ | ⊚ | ⊚ | ⊚ | ◯ | ◯ | Δ | Δ | Δ | Δ | X |
| ness | Glass | ⊚ | ⊚ | ⊚ | ⊚ | ⊚ | ◯ | ◯ | Δ | Δ | Δ | Δ | X |

The components shown in Table 1 are as follows.
Polyol compound 1: Bifunctional polypropylene glycol (Excenol 2020, manufactured by Asahi Glass Co., Ltd.)
Polyol compound 2: Trifunctional polypropylene glycol (Excenol 5030, manufactured by Asahi Glass Co., Ltd.)
Plasticizer: Diisononyl adipate (manufactured by J-PLUS Co., Ltd.)
Carbon black: Mixture of carbon black 1 (Niteron #200, manufactured by NSCC Carbon Co., Ltd.) and carbon black 2 (Niteron #300, manufactured by NSCC Carbon Co., Ltd.) (mass ratio=75/25)
Calcium carbonate: Heavy calcium carbonate (Super S, manufactured by Maruo Calcium Co., Ltd.)
MDI: Diphenylmethane diisocyanate (Cosmonate PH, manufactured by Mitsui Chemicals, Inc.)
Metal catalyst: Bismuth catalyst (Neostann U-600, manufactured by Nitto Kasei Co., Ltd.)
HDI biuret-aminosilane: Compound obtained by reacting a biuret of hexamethylene diisocyanate (Takenate D-165N, manufactured by Mitsui Chemicals, Inc.) with N-phenyl-3-aminopropyl trimethoxysilane (KBM-573, manufactured by Shin-Etsu Chemical Co., Ltd.) so as to result in an NCO/NH ratio of 3/1
HDI TMP adduct-aminosilane: Compound obtained by reacting a reaction product of hexamethylene diisocyanate and trimethylolpropane (Takenate D-160N, manufactured by Mitsui Chemicals, Inc.) with N-phenyl-3-aminopropyl trimethoxysilane (KBM-573, manufactured by Shin-Etsu Chemical Co., Ltd.) so as to result in an NCO/NH ratio of 3/1
HDI isocyanurate-aminosilane: Compound obtained by reacting an isocyanurate of hexamethylene diisocyanate (Takenate D-170N, manufactured by Mitsui Chemicals, Inc.) with N-phenyl-3-aminopropyl trimethoxysilane (KBM-573, manufactured by Shin-Etsu Chemical Co., Ltd.) so as to result in an NCO/NH ratio of 3/1
HDI-aminosilane: Compound obtained by reacting hexamethylene diisocyanate (Duranate 50M-HDI, manufactured by Asahi Kasei Corporation) with N-phenyl-3-aminopropyl trimethoxysilane (KBM-573, manufactured by Shin-Etsu Chemical Co., Ltd.) so as to result in an NCO/NH ratio of 3/1
Aromatic isocyanate compound-aminosilane: Compound obtained by reacting diphenylmethane diisocyanate (Cosmonate PH, manufactured by Mitsui Chemicals, Inc.) with N-phenyl-3-aminopropyl trimethoxysilane (KBM-573, manufactured by Shin-Etsu Chemical Co., Ltd.) so as to result in an NCO/NH ratio of 3/1
Curing catalyst: Tin catalyst (Neostann U-810, manufactured by Nitto Kasei Co., Ltd.)

As is clear from the results shown in Table 1, the compositions of Working Examples 1 to 7 obtained by adding and mixing the reaction product (D) after producing a urethane prepolymer had good adhesiveness to a painted steel sheet and glass.

In contrast, the composition of Comparative Example 1, in which a reaction product of an aromatic isocyanate compound was added instead of the reaction product (D) which is the reaction product of the aliphatic isocyanate compound (d1), had poor adhesiveness.

Furthermore, the compositions of Comparative Examples 2 to 4, in which the reaction product (D) was added at the same time as the polyisocyanate compound (C) in the urethane prepolymer production step, also had poor adhesiveness.

Additionally, Comparative Example 5, in which the reaction product (D) was not later added, also had worse adhesiveness than Comparative Examples 1 to 4.

1. A method for producing a one-pack moisture-curing polyurethane composition comprising the steps of: a mixing step of mixing a liquid component (A) containing a polyol compound having not less than two hydroxy groups per molecule and a powder component (B) containing a filler, and obtaining a paste-like mixture of the liquid component (A) and the powder component (B);
a dehydration step of removing at least part of residual moisture in the paste-like mixture after the mixing step;
a prepolymer production step of mixing a polyisocyanate compound (C) having not less than two isocyanate groups per molecule and the paste-like mixture after the dehydration step, and obtaining a mixture containing a urethane prepolymer produced by a reaction between the polyisocyanate compound (C) and the polyol compound in the paste-like mixture; and
a composition production step of mixing the above mixture with a reaction product (D) of an aliphatic isocyanate compound (d1) having not less than two isocyanate groups per molecule and an alkoxysilane (d2), and obtaining a one-pack moisture-curing polyurethane composition.

2. The method for producing a one-pack moisture-curing polyurethane composition according to claim 1, wherein the dehydration step is a step of dehydrating the paste-like mixture such that a moisture content of the paste-like mixture is not greater than 0.050% by mass.

3. The method for producing a one-pack moisture-curing polyurethane composition according to claim 1, wherein, in the composition production step, a curing catalyst for inducing moisture curing of the one-pack moisture-curing polyurethane composition is further added.

4. The method for producing a one-pack moisture-curing polyurethane composition according to claim 1, wherein, in the prepolymer production step, the polyisocyanate compound (C) and the paste-like mixture obtained by the mixing step are added in that order and mixed.

5. The method for producing a one-pack moisture-curing polyurethane composition according to claim 1, wherein, in the prepolymer production step, the polyisocyanate compound (C) and the paste-like mixture obtained by the mixing step are mixed, and then, a metal catalyst that promotes production reaction of urethane prepolymer is further added and mixed.

6. The method for producing a one-pack moisture-curing polyurethane composition according to claim 1, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

7. The method for producing a one-pack moisture-curing polyurethane composition according to claim 3, wherein, in the prepolymer production step, the polyisocyanate compound (C) and the paste-like mixture obtained by the mixing step are added in that order and mixed.

8. The method for producing a one-pack moisture-curing polyurethane composition according to claim 4, wherein, in the prepolymer production step, the polyisocyanate compound (C) and the paste-like mixture obtained by the mixing step are mixed, and then, a metal catalyst that promotes production reaction of urethane prepolymer is further added and mixed.

9. The method for producing a one-pack moisture-curing polyurethane composition according to claim 7, wherein, in the prepolymer production step, the polyisocyanate compound (C) and the paste-like mixture obtained by the mixing step are mixed, and then, a metal catalyst that promotes production reaction of urethane prepolymer is further added and mixed.

10. The method for producing a one-pack moisture-curing polyurethane composition according to claim 3, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

11. The method for producing a one-pack moisture-curing polyurethane composition according to claim 4, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

12. The method for producing a one-pack moisture-curing polyurethane composition according to claim 5, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

13. The method for producing a one-pack moisture-curing polyurethane composition according to claim 7, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

14. The method for producing a one-pack moisture-curing polyurethane composition according to claim 8, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.

15. The method for producing a one-pack moisture-curing polyurethane composition according to claim 9, wherein the reaction product (D) is a reaction product of at least one type selected from the group consisting of a reaction product of hexamethylene diisocyanate and trimethylolpropane, a biuret of hexamethylene diisocyanate, and an isocyanurate of hexamethylene diisocyanate; and an imino group-containing alkoxysilane.
